(19) United States
(12) Patent Application Publication
(10) Pub. No.: US 2015/0007685 A1
(43) Pub. Date: Jan. 8, 2015

(54) SEVEN UNIVERSE INDUSTRIAL CO., LTD.

(71) Applicant: SEVEN UNIVERSE INDUSTRIAL CO., LTD., Taichung County (TW)

(72) Inventor: Pao-Chi CHANG, TAICHUNG (TW)

(21) Appl. No.: 13/934,774

(22) Filed: Jul. 3, 2013

(51) Int. Cl. G05G 1/10; G05G 1/02

(52) U.S. Cl. CPC G05G 1/10; G05G 1/02
USPC 74/553

(57) ABSTRACT

The present invention provides a button set for gas valve, which is characterized by that, multiple oil chambers are set on inner wall of the axle hole of the axle hole on the upper cover of the button set in relation to the surface of the rotating axle; this could accommodate lubricant and reduce the contact area between the rotating axle and axle hole, thus improving the rotating smoothness of the rotating axle within the axle hole and reducing the machining accuracy.

### BACKGROUND OF INVENTION

1. Field of the Invention

The present invention relates generally to a gas switch, and more particularly to an innovative one which is designed into a button set for gas valve that can be easily processed while permanent lubrication of the axle hole and rotating axle is made possible.

2. Description of Related Art

Gas switch is a highly mature product benefited from many innovations and patents; it generally comprises a switch body with one opening, a closer set arranged into the switch body, and a button set arranged at one end of the switch body and linked to the closer set.

The button set for conventional gas switch is generally composed of an upper cover, a rotating axle and a rotary button; of which the upper cover is used to seal the switch body, the rotating axle is linked to the closer set by passing through the axle hole of the upper cover, the rotary button is arranged externally onto the rotating axle, allowing to pinch it by finger, then press and rotate the rotating axle. Referring to FIG. 1, a small gap 4 for accommodating lubricant is often set between the rotating axle 1 of the button set and the axle hole 3 of the upper cover 2, such that the rotating axle 1 could be rotated smoothly. Yet, if the rotating axle 1 is numerously pressed and rotated, the lubricant will leak gradually, leading to unsmooth rotation of the rotating axle 1.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide a button set for gas valve, which can contain a larger amount of lubricant oil, thus prolonging the lubrication between the rotating axle and axle hole, reducing the contact area between the external side of the rotating axle and the inner wall of the axle hole, and greatly enhancing the smoothness of the rotation of the axle. The present invention has great practical values.

In order to achieve the above-mentioned purposes, the present invention provides a button set for gas valve. Said gas valve comprises a main body and a closer set that can rotate inside the main body; said button set, which is installed at one end of the main body and is connected to the closer set for driving said closer set, comprising a upper cover, which is placed at one end of the main body and has a axle hole; a rotating axle, which can fit through the axle hole of the upper cover; its feature lies in the oil chamber between the axle hole of the upper cover and the rotating axle.

### BRIEF DESCRIPTION OF THE DRAWINGS

FIG. 1 is a partial sectional view of a conventional gas switch.

FIG. 2 is a partial sectional view of the first preferred embodiment of the present invention.

FIG. 3 is a sectional view of the upper cover in the first preferred embodiment of the present invention.

FIG. 4 is a partial sectional view of the second preferred embodiment of the present invention.

FIG. 5 is a partial sectional view of the third preferred embodiment of the present invention.

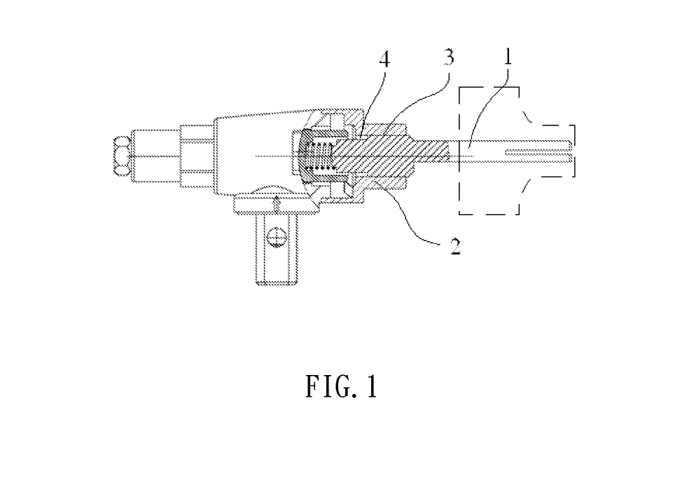

### DETAILED DESCRIPTION OF THE INVENTION

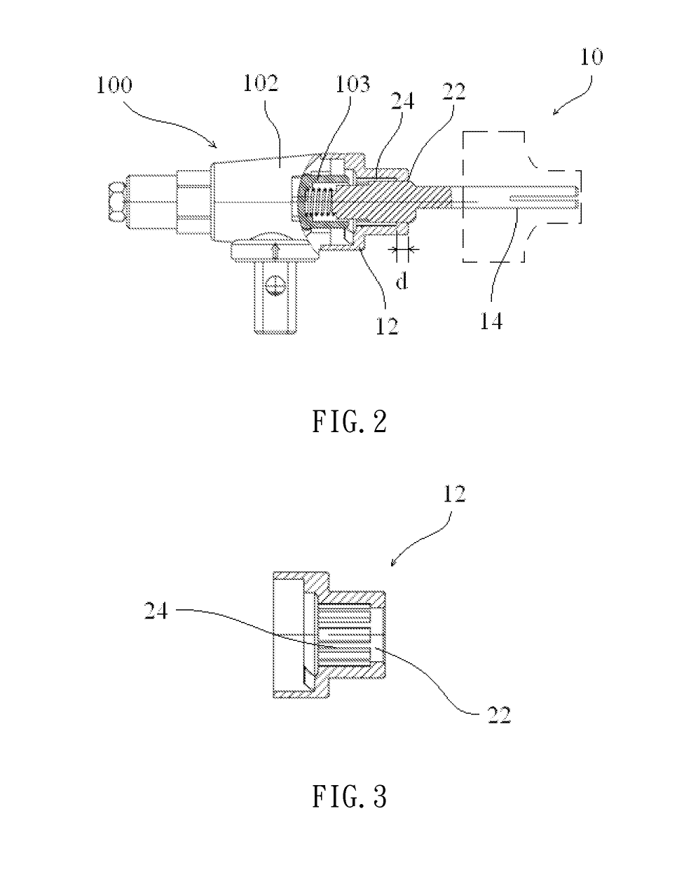

As shown in FIGS. 2 and 3, the button set 10 for the gas valve 100 of the first preferred embodiment of the present invention, wherein said gas valve 100 is a conventional gas switch, comprising: a main body 102 with one opening and a closer set 103 rotarily arranged into the main body 102, the button set 10 is arranged at one end of the main body 102 and connected to the closer set 103, so as to actuate the rotation of the closer set 103; it comprises of an upper cover 12 sealed at one end of the main body 102, a rotating axle 14 linked to the closer set 103 by passing rotarily through the axle hole 22 of the upper cover 12, a rotary button 16, arranged externally onto the rotating axle 14 for its rotation; the button set 10, the main body 102 and closer set 103 are connected and driven in the same way of conventional gas switch; the button set 10 of the present invention is characterized by that:

An oil chamber 24 formed by multiple long grooves is set on inner wall of the axle hole 22 of the upper cover 12, and extended axially to the rotating axle 14 from one end of the closer set 103 correspondingly to the axle hole 22; it keeps a distance d from the other end of the axle hole 22, so that multiple spaces for accommodating lubricant are formed between the inner wall of the axle hole 22 and the surface of the rotating axle 14.

With this design, the features and efficacies of the button set 10 of the gas valve are described below:

As an oil chamber 24 formed by multiple long grooves is set on inner wall of the axle hole 22 of the upper cover 12, this could reduce the contact area between the rotating axle 14 and axle hole 22, but also accommodate more lubricant, helping to maintain a long lubricating state of the rotating axle 14 and axle hole 22, and increase the rotating smoothness of the rotating axle 14 within the axle hole 22. Provided that the contact area between the rotating axle 14 and axle hole 22 is reduced, the axle hole 22 could be machined (e.g. reamed) more easily.

As the button set 10 of the gas valve of the present invention is concerned, an oil chamber 24 is set on the inner wall of the axle hole 22, so the contact position of the inner wall of the axle hole 22 or exterior of the rotating axle 14 could be continuously lubricated, thus reducing the contact area between the exterior of the rotating axle 14 and the inner wall of the axle hole 22, and also improving greatly the rotating smoothness of the rotating axle 14.

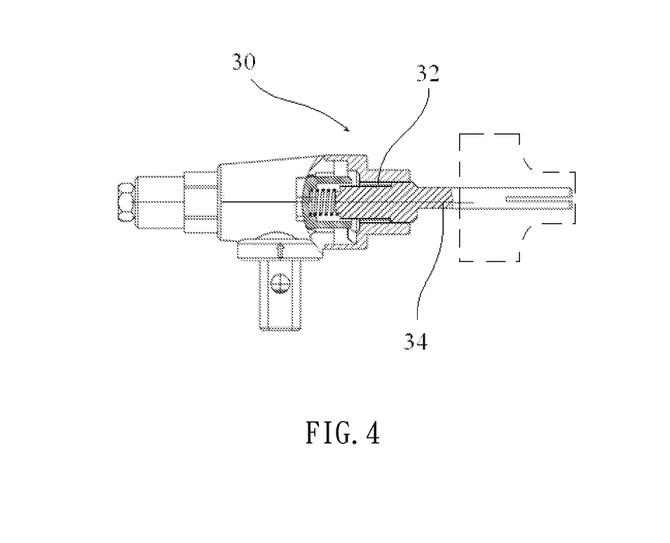

Referring to FIG. 4, the button set 30 of the gas valve in the second preferred embodiment of the present invention has a structure almost the same with the aforementioned embodiment. The difference lies in that: the oil chamber 32 formed by multiple long grooves is set on the surface of the rotating axle 34, and extended along the axial direction of the rotating axle 34. With this design, the button set 30 enables to improve the rotating smoothness and mach inability of the rotating axle.

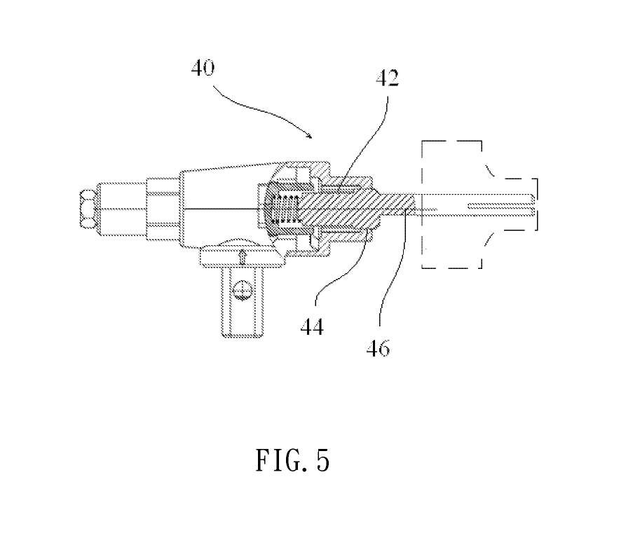

Referring to FIG. 5, the button set 40 of the gas valve in the third preferred embodiment of the present invention has a structure almost the same with the aforementioned embodiment. The difference lies in that: the oil chamber 42 formed by multiple long grooves is set simultaneously on the inner wall of the axle hole 44 and the surface of the rotating axle 46. With this design, the oil chamber 42 of the button set 40 could accommodate more lubricant, and also improve the rotating smoothness and mach inability of the rotating axle.

It is worthy to note that, the oil chamber of the present invention could also be designed into spiral pattern, extended radially or embossed in relation to the rotating axle, and only required to accumulate lubricant between the rotating axle and axle hole, reducing the contact area between the rotating axle and axle hole.

What is claimed is:

1. A button set for gas valve, of which the gas valve comprises a main body and a closer set rotarily arranged into the main body, and the button set is arranged at one end of the main body and linked to the closer set for driving the rotation of the closer set; comprising:
an upper cover, set at one end of the main body with an axle hole;
a rotating axle, rotarily set into the axle hole of the upper cover; and
multiple oil chambers are set between the axle hole of the upper cover and the rotating axle, this could accommodate lubricant to maintain the rotating smoothness of the rotating axle in the axle hole, and reduce the contact area between the inner wall of the axle hole and the rotating axle.

2. The structure defined in claim 1, wherein said oil chamber is set onto inner wall of the axle hole.

3. The structure defined in claim 2, wherein said oil chamber is formed by multiple grooves, and extended between one end of the axle hole correspondingly to the closer set and the inner wall at other end of the axle hole.

4. The structure defined in claim 3, wherein said grooves are of elongated pattern and extended axially in parallel to the rotating axle.

5. The structure defined in claim 1, wherein said oil chamber is set on the surface of the rotating axle.

6. The structure defined in claim 5, wherein said oil chamber is formed by multiple grooves.

7. The structure defined in claim 6, wherein said grooves are of elongated pattern and extended axially in parallel to the rotating axle.

8. The structure defined in claim 1, wherein said oil chamber is set on inner wall of the axle hole and surface of the rotating axle.

9. The structure defined in claim 8, wherein said oil chamber is formed by multiple grooves.

10. The structure defined in claim 9, wherein said grooves are of elongated pattern and extended axially in parallel to the rotating axle.
